(19) United States
(12) Patent Application Publication
(10) Pub. No.: US 2005/0246305 A1
(43) Pub. Date: Nov. 3, 2005

(54) Knowledge slicing and encapsulating method in a semiconductor manufacturing system

(75) Inventor: Chih-Tsung Lin, Hsinchu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/800,175

(22) Filed: Mar. 12, 2004

(51) Int. Cl. G06N 5/02

(52) U.S. Cl. 706/50

(57) ABSTRACT

The present disclosure provides a method and system for managing semiconductor manufacturing knowledge. A hierarchy of interests in the semiconductor knowledge including data targets and results is defined. A connectivity relationship diagram to reflect the dependency between the data targets and the results is developed and implemented, so that the semiconductor knowledge is available to any authorized user.

### BACKGROUND

The present disclosure relates generally to the field of semiconductor manufacturing and, more particularly, to a system and method for managing semiconductor manufacturing knowledge, which may be used for improving readability and reusability in decision support and diagnosis system incorporated.

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing have been needed. For example, an IC is formed by creating one or more devices (e.g., circuit components) on a substrate using a fabrication process. As the geometry of such devices is reduced to the submicron or deep submicron level, the IC's active device density (i.e., the number of devices per IC area) and functional density (i.e., the number of interconnected devices per IC area) has become limited by the fabrication process.

Furthermore, as the IC industry has matured, the various operations needed to produce an IC may be performed at different locations by a single company or by different companies that specialize in a particular area. This further increases the complexity of producing ICs, as companies and their customers may be separated not only geographically, but also by time zones, making effective communication more difficult. For example, a first company (e.g., an IC design house) may design a new IC, a second company (e.g., an IC foundry) may provide the processing facilities used to fabricate the design, and a third company may assemble and test the fabricated IC. A fourth company may handle the overall manufacturing of the IC, including coordination of the design, processing, assembly, and testing operations.

The automation and organization of information in a manufacturing environment and can be an overwhelming task to control and maintain. The general operation and control of a manufacturing system may involve a vast plurality of servers, specifications, process equipment, automation, and support personnel, each including or generating interrelated knowledge. Automated software and systems can be established, which can organize, maintain, and control systems in the manufacturing environment. The information technology (IT) infrastructure may include a plurality of systems that may be designated as experts. Experts systems typically contain a base of knowledge or domain knowledge and set of algorithms or rules that infer new facts from existing knowledge and incoming data, which may provide information to other systems and be able to provide decision support and diagnosis. In decision support and diagnosis systems, the domain knowledge can dominate the accuracy of inference results.

Accordingly, what is needed is a system and method for managing semiconductor manufacturing knowledge, which may be used for improving accessibility and reusability in decision support and diagnosis systems.

### BRIEF DESCRIPTION OF THE DRAWINGS

FIG. 1(a) is a diagram illustrating an embodiment of a semiconductor manufacturing knowledge management system.

FIG. 1(b) illustrates an example DMLD environment.

FIG. 1(c) is a diagram illustrating a software interface environment of the expert system.

FIG. 2 depicts an example virtual integrated circuit fabrication system, including an example computer system for implementing one embodiment of the present disclosure.

FIG. 3 depicts a more detailed example of the virtual integrated circuit fabrication system of FIG. 2.

FIG. 4 shows a more detailed illustration of the semiconductor manufacturing knowledge management system of FIG. 1.

FIG. 5(a) is a diagram of a conceptual layer.

FIG. 5(b) is a more detailed diagram of the conceptual layer of FIG. 5(a).

FIG. 5(c) is a diagram of a conceptual layer tailored to semiconductor manufacturing facility.

FIG. 5(d) is a diagram of a conceptual layer tailored to a pilot management component of a semiconductor manufacturing facility.

FIG. 6(a) is a diagram of a logic layer.

FIG. 6(b) illustrates example standard gates and nodes to be used in the logic layer of FIG. 6(a).

FIG. 6(c) is a diagram of a logic layer tailored to semiconductor manufacturing facility.

FIG. 7 is a diagram of an implementation layer.

FIG. 8(a) is a graphical representation illustrating the encapsulation of the conceptual layer, the logic layer and the implementation layer.

FIG. 8(b) is a graphical representation illustrating the connectivity of a plurality integrated circuits of FIG. 8(a).

FIG. 9 illustrated an example graphical user interface to implement the system of FIGS. 1 and 4.

### DETAILED DESCRIPTION

The present disclosure relates generally to the field of semiconductor manufacturing and, more particularly, to a system and method for method for managing semiconductor manufacturing knowledge, which may be used for improving readability and reusability in decision support and diagnosis system. It is understood, however, that the following disclosure provides many different embodiments, or examples, for implementing different features of the system and method. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

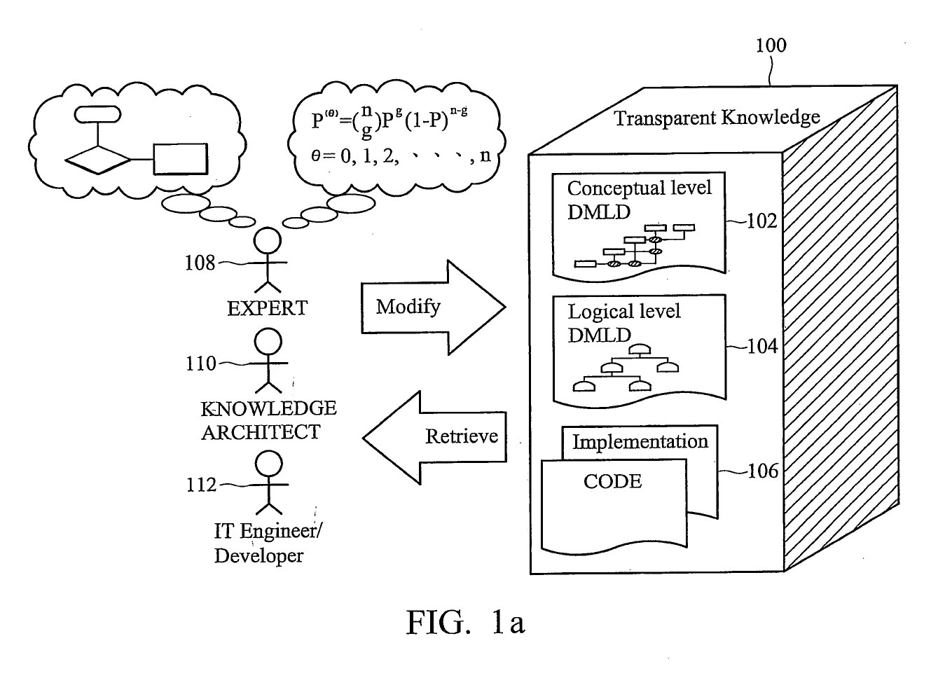

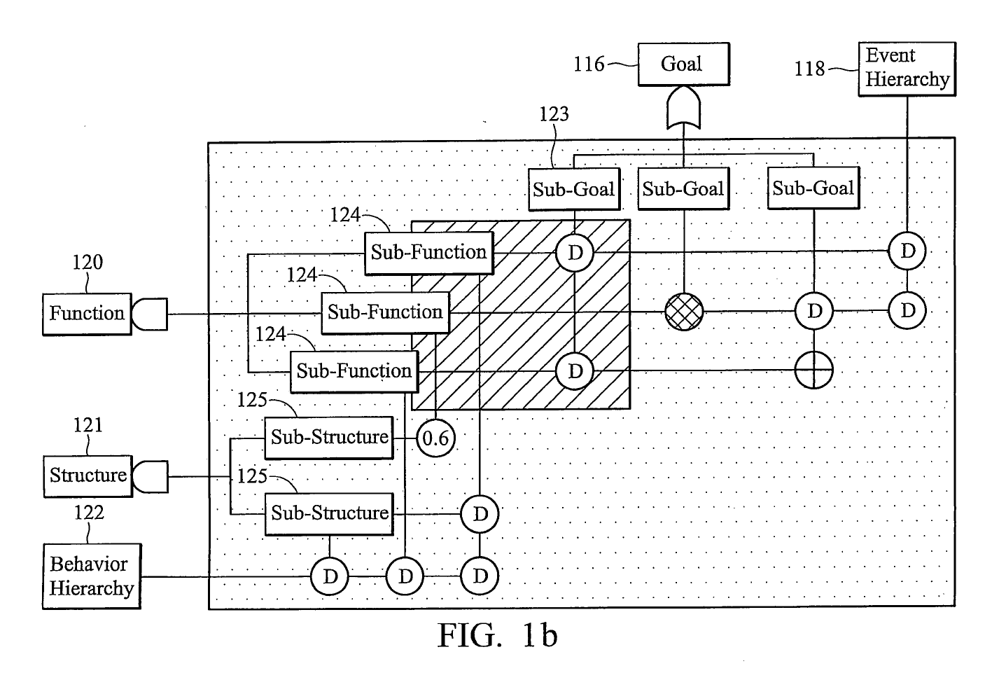

In a semiconductor manufacturing facility significant volumes of knowledge exist, such as high level business knowledge regarding the overall operation and performance of a manufactuing facility, the desired performance of a prcessing tool, the real-time process test data, historical process data, process tool requirements, temperature measurements, etc. Seminconductor manufacturing systems are complex systems that may be represented in the form of a hierarchy. Complex systems are composed of interreleated subsystems that have in turn their own subsystems, and so on, until some lowest level of elementary components is reached. FIG. 1(a) provides a highlevel illustration of one embodiment of a system for managing semiconductor manufacturing knowledge 100, which is broken into three knowledge levels; the conceptual level 102, the logical/design level 104 and implementation level 106.

Conceptual level 102 may be a repository for a hierarchy of interests in the semiconductor knowledge, stressing the goal, event, function, structure and behavior relationships in a semiconductor manufacturing facility and the manner in which various hardware, software, and people intersct with each other to attaining results (goals and events). The logical/design level 104 demonstrates the logical cause and effect between the function, structure and behavior components and the goal and event components of the conceptual layer. Implementations level 106 is the resource accessing level designed to feed data from predefined function, structure or behaviour sources through the logical/design level 104 to the conceptual level 102.

System 100 provides access to all three knowledge levels 102, 104, and 106 to any one with authorization, including experts 108, knowledge architects 110, and developer or IT engineers 112. Experts 108 typically work with the conceptual level providing requirements documents and high level operations dependency information. Knowledge architect may work alone or coorperatively with expert to compose a logical representation of the relationship between the conceptual level and the implementation level. The IT Engineer or developer may generate the code to implement the logical representation.

In one embodiment of system 100, a dynamic master logic diagram (“DMLD”) is utilized to generate the relationship representation in the logical level 104. DMLD is a logic-based diagram that models the dynamic behavior of a physical system and is described in the paper entitled “Evaluating System Behavior Through Dynamic Master Logic Diagram (DMLD) Modeling”, authored by Yu-Shu Hu and Mohammad Modarres, published in Reliability Engineering and System Safety 64 (1999), pages 241-269, which is herein incorporated by reference. A method for organizing and controlling all operations of a semiconductor manufacturing system may be accomplished by the use of such logic-based diagram where systematic control and response may be illustrated. Boolean operators and other graphical operators may be utilized for modeling and controlling a system. The logic-based diagram can be dynamic and able to change responses according to changes in systems and implementations.

FIG. 1(b) shows how a hierarchy of interest may be defined in a function-centered-model-based DMLD environment. For example, goal hierarchy 116, event hierarchy 118, function hierarchy 120, structure hierarchy 121, and behavioral hierarchy 122 are options for the DMLD. For each hierarchy, the top object is first decomposed in to sub-objects, such as for example sub-goals 123, sub-functions 124 and sub-structures 125. For a specific sub-object, which requires multiple modes, fuzzy (uncertain) modes may be represented (not shown). Fuzzy modes or objects can be linked logically to support specific fuzzy modes or object through he dependency matrix. Time dependency is represented by transition gates. However, not all objects are dynamic and require modes. The design of the DMLD is to provide a consistent representation that shows the details of the system behavior.

Utilizing a DMLD, the goals, event, function, structure, and behavior of the conceptual level 102 knowledge may be coupled in the design/logic level 104 by logical Boolean operators that may be triggered when certain event occurs. A domain expert 108 may trace and route the relationship of functions, structures, behaviors, events and goals within the conceptual level 104. Weighting of functions, structures, behaviors, events and goals may also be achieved using the DMLD. A knowledge architect 110 can implement the inference flow and fabricate a logic system for the design(logic) layer. The logical system can include functions, structures, behaviors, events and goals and Boolean logical operators which can designate cause and reaction. The logical system may serve to maintain systems and can also be used to control functions, structures, behaviors, events and goals. The inference flow for each operation may be defined where a specific result or event may trigger another event or responses. A goal or event may further trigger a cascade or plurality of events or responses.

System 100 may utilize the concepts of an expert system and provide input to other expert systems. FIG. 1(c) illustrates a software interface environment of the expert system 128. Expert system 128 may include a knowledge base 130 and an inference engine 132. Input to the expert 128 system may be accomplished by user 134, which could be expert 108, knowledge architect 110, IT engineer/developer 112, the system 100, other expert system or any other data generating source. Knowledge base 130 stores information or facts. Inference engine 132 provides user 134 information or expertise based on the knowledge stored in the knowledge base 130.

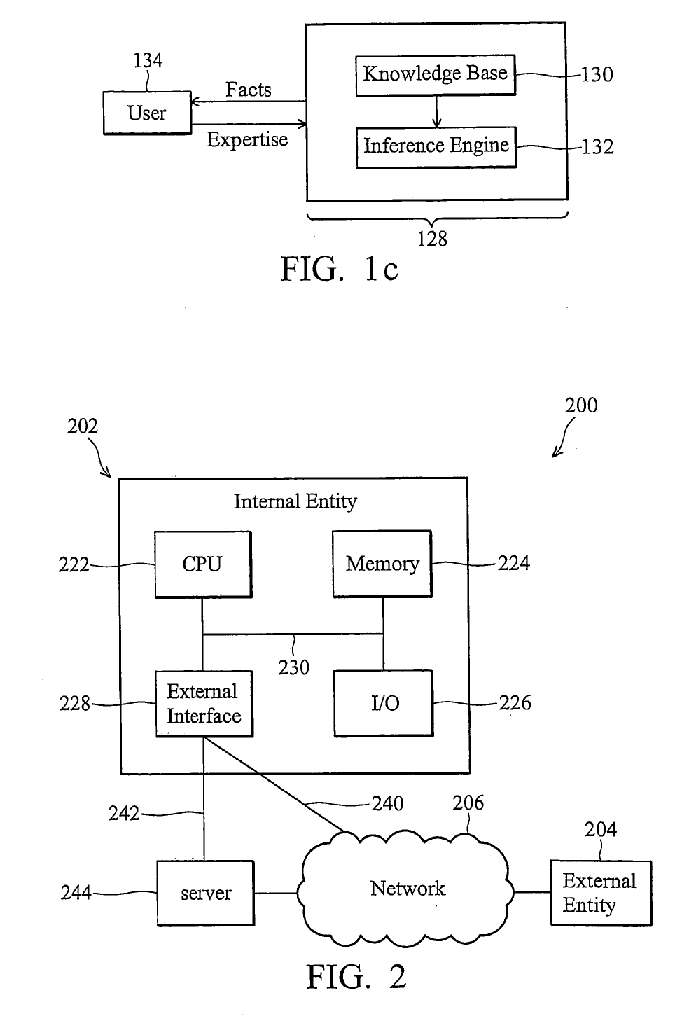

Referring now to FIG. 2, in another embodiment, a virtual IC fabrication system (a “virtual fab”) 200, within which the system 100 of FIG. 1 may be implemented, is illustrated. The virtual fab includes a plurality of entities, represented by one or more internal entities 202 and one or more external entities 204 that are connected by a communications network 206. The network 206 may be a single network or may be a variety of different networks, such as an intranet and the Internet, and may include both wireline and wireless communication channels.

Each of the entities 202, 204 may include one or more computing devices such as personal computers, personal digital assistants, pagers, cellular telephones, and the like. For the sake of example, the internal entity 202 is expanded to show a central processing unit (CPU) 222, a memory unit 224, an input/output (I/O) device 226, and an external interface 228. The external interface may be, for example, a modem, a wireless transceiver, and/or one or more network interface cards (NICs). The components 222-228 are interconnected by a bus system 230. It is understood that the internal entity 202 may be differently configured and that each of the listed components may actually represent several different components. For example, the CPU 222 may actually represent a multi-processor or a distributed processing system; the memory unit 224 may include different levels of cache memory, main memory, hard disks, and remote storage locations; and the I/O device 226 may include monitors, keyboards, and the like.

The internal entity 202 may be connected to the communications network 214 through a wireless or wired link 240, and/or through an intermediate network 242, which may be further connected to the communications network. The intermediate network 242 may be, for example, a complete network or a subnet of a local area network, a company wide intranet, and/or the Internet. The internal entity 202 may be identified on one or both of the networks 214, 242 by an address or a combination of addresses, such as a media control access (MAC) address associated with the network interface 228 and an internet protocol (IP) address. Because the internal entity 202 may be connected to the intermediate network 242, certain components may, at times, be shared with other internal entities. Therefore, a wide range of flexibility is anticipated in the configuration of the internal entity 202. Furthermore, it is understood that, in some implementations, a server 244 may be provided to support multiple internal entities 202. In other implementations, a combination of one or more servers and computers may together represent a single entity.

In the present example, the internal entities 202 represents those entities that are directly responsible for producing the end product, such as a wafer or individually tested IC devices. Examples of internal entities 202 include an engineer, customer service personnel, an automated system process, a design or fabrication facility and fab-related facilities such as raw-materials, shipping, assembly or test. Examples of external entities 204 include a customer, a design provider; and other facilities that are not directly associated or under the control of the fab. In addition, additional fabs and/or virtual fabs can be included with the internal or external entities. Each entity may interact with other entities and may provide services to and/or receive services from the other entities.

It is understood that the entities 202-204 may be concentrated at a single location or may be distributed, and that some entities may be incorporated into other entities. In addition, each entity 202, 204 may be associated with system identification information that allows access to information within the system to be controlled based upon authority levels associated with each entities identification information.

The virtual fab 200 enables interaction among the entities 202-204 for purposes related to IC manufacturing, as well as the provision of services. In the present example, IC manufacturing can include one or more of the following steps:

receiving or modifying a customer's IC order of price, delivery, and/or quantity;

receiving or modifying an IC design;

receiving or modifying a process flow;

receiving or modifying a circuit design;

receiving or modifying a mask change;

receiving or modifying testing parameters;

receiving or modifying assembly parameters; and

receiving or modifying shipping of the ICs.

One or more of the services provided by the virtual fab 200 may enable collaboration and information access in such areas as design, engineering, and logistics. For example, in the design area, the customer 204 may be given access to information and tools related to the design of their product via the fab 202. The tools may enable the customer 204 to perform yield enhancement analyses, view layout information, and obtain similar information. In the engineering area, the engineer 202 may collaborate with other engineers 202 using fabrication information regarding pilot yield runs, risk analysis, quality, and reliability. The logistics area may provide the customer 204 with fabrication status, testing results, order handling, and shipping dates. It is understood that these areas are exemplary, and that more or less information may be made available via the virtual fab 200 as desired.

Another service provided by the virtual fab 200 may integrate systems between facilities, such as between a facility 204 and the fab facility 202. Such integration enables facilities to coordinate their activities. For example, integrating the design facility 204 and the fab facility 202 may enable design information to be incorporated more efficiently into the fabrication process, and may enable data from the fabrication process to be returned to the design facility 204 for evaluation and incorporation into later versions of an IC.

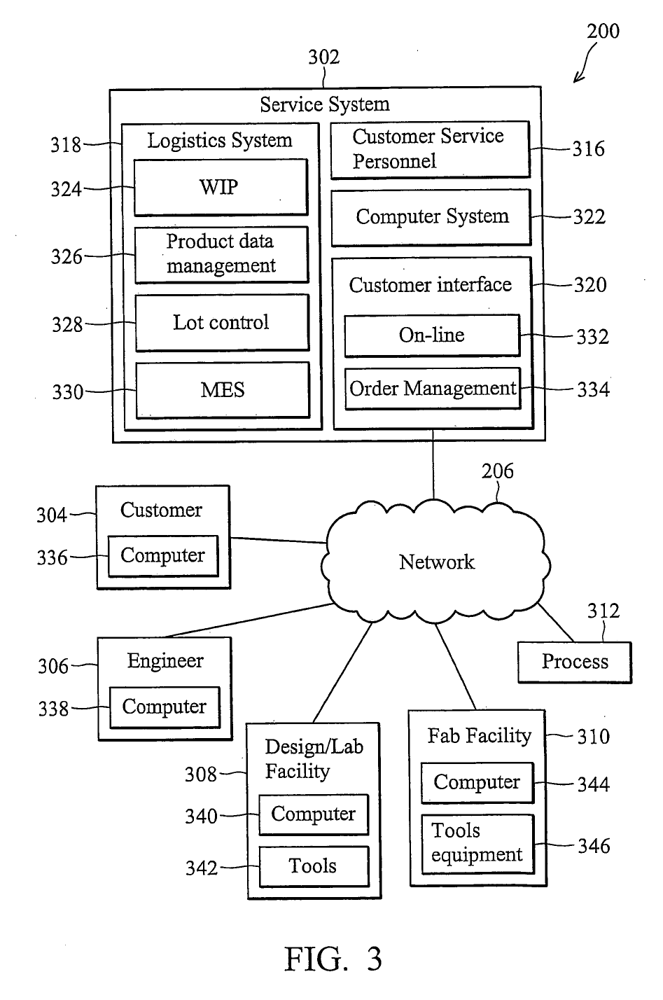

Referring now to FIG. 3, a virtual fab 300 illustrates a more detailed example of the virtual fab 200 of FIG. 2. It is understood, however, that the details mentioned and described in FIG. 3 are provided for the sake of example, and that other examples can also be used.

The virtual fab 300 includes a plurality of entities 302, 304, 306, 308, 310, and 312 that are connected by a communications network 314. In the present example, the entity 302 represents a service system, the entity 304 represents a customer, the entity 306 represents an engineer, the entity 308 represents a design/lab facility for IC design and testing, the entity 310 represents a fab facility, and the entity 312 represents a process (e.g., an automated fabrication process) either inside the fab 310, or at another facility. Each entity may interact with other entities and may provide services to and/or receive services from the other entities.

The service system 302 provides an interface between the customer and the IC manufacturing operations. For example, the service system 302 may include customer service personnel 316, a logistics system 318 for order handling and tracking, and a customer interface 320 for enabling a customer to directly access various aspects of an order.

The logistics system 318 may include a work-in-process (WIP) inventory system 324, a product data management system 326, a lot control system 328, and a manufacturing execution system (MES) 330. The WIP inventory system 324 may track working lots using a database (not shown). The product data management system 326 may manage product data and maintain a product database (not shown). The product database could include product categories (e.g., part, part numbers, and associated information), as well as a set of process stages that are associated with each category of products. The lot control system 328 may convert a process stage to its corresponding process steps.

The MES 330 may be an integrated computer system representing the methods and tools used to accomplish production. In the present example, the primary functions of the MES 330 may include collecting data in real time, organizing and storing the data in a centralized database, work order management, workstation management, process management, inventory tracking, and document control. The MES 330 may be connected to other systems both within the service system 302 and outside of the service system 302. Examples of the MES 330 include Promis (Brooks Automation Inc. of Massachusetts), Workstream (Applied Materials, Inc. of California), Poseidon (IBM Corporation of New York), and Mirl-MES (Mechanical Industry Research Laboratories of Taiwan). Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. The MES 330 may include such information as a process step sequence for each product.

The customer interface 320 may include an online system 332 and an order management system 334. The online system 332 may function as an interface to communicate with the customer 304, other systems within the service system 302, supporting databases (not shown), and other entities 306-312. The order management system 334 may manage client orders and may be associated with a supporting database (not shown) to maintain client information and associated order information.

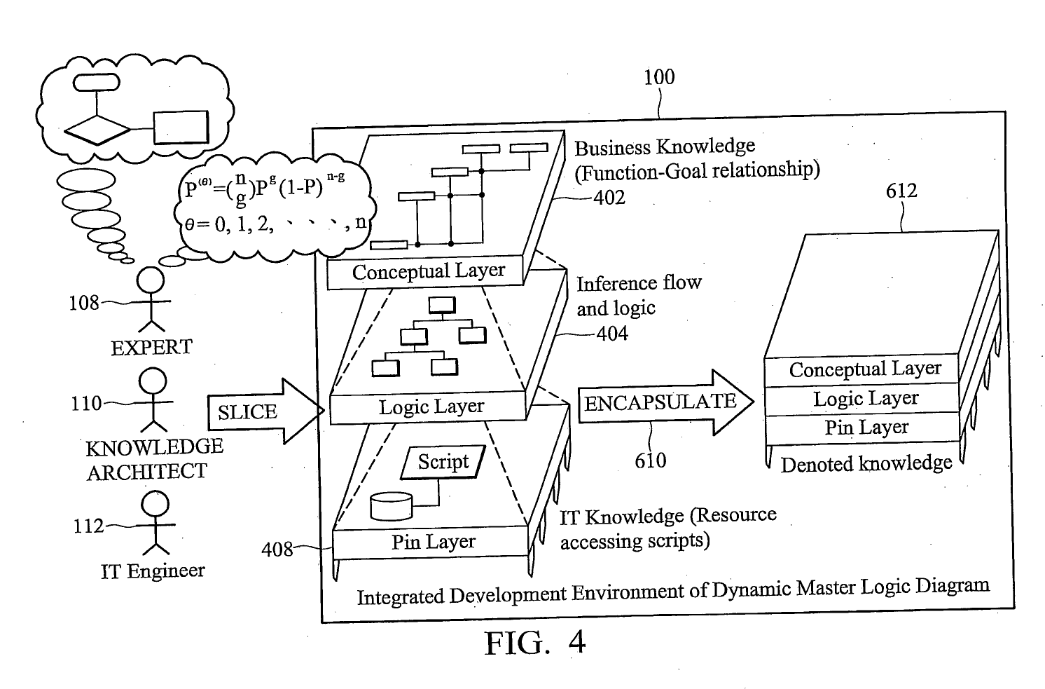

Portions of the service system 302, such as the customer interface 320, may be associated with a computer system 322 or may have their own computer systems. In some embodiments, the computer system 322 may include multiple computers (FIG. 4), some of which may operate as servers to provide services to the customer 304 or other entities. The service system 302 may also provide such services as identification validation and access control, both to prevent unauthorized users from accessing data and to ensure that an authorized customer can access only their own data.

The customer 304 may obtain information about the manufacturing of its ICs via the virtual fab 300 using a computer system 336. In the present example, the customer 304 may access the various entities 302, 306-312 of the virtual fab 300 through the customer interface 320 provided by the service system 302. However, in some situations, it may be desirable to enable the customer 304 to access other entities without going through the customer interface 320. For example, the customer 304 may directly access the fab facility 310 to obtain fabrication related data.

The engineer 306 may collaborate in the IC manufacturing process with other entities of the virtual fab 300 using a computer system 338. The virtual fab 300 enables the engineer 306 to collaborate with other engineers and the design/lab facility 308 in IC design and testing, to monitor fabrication processes at the fab facility 310, and to obtain information regarding test runs, yields, etc. In some embodiments, the engineer 306 may communicate directly with the customer 304 via the virtual fab 300 to address design issues and other concerns.

The design/lab facility 308 provides IC design and testing services that may be accessed by other entities via the virtual fab 300. The design/lab facility 308 may include a computer system 340 and various IC design and testing tools 342. The IC design and testing tools 342 may include both software and hardware.

The fab facility 310 enables the fabrication of ICs. Control of various aspects of the fabrication process, as well as data collected during the fabrication process, may be accessed via the virtual fab 300. The fab facility 310 may include a computer system 344 and various fabrication hardware and software tools and equipment 346. For example, the fab facility 310 may include an ion implantation tool, a chemical vapor deposition tool, a thermal oxidation tool, a sputtering tool, and various optical imaging systems, as well as the software needed to control these components.

The process 312 may represent any process or operation that occurs within the virtual fab 300. For example, the process 312 may be an order process that receives an IC order from the customer 304 via the service system 302, a fabrication process that runs within the fab facility 310, a design process executed by the engineer 306 using the design/lab facility 308, or a communications protocol that facilities communications between the various entities 302-312.

It is understood that the entities 302-312 of the virtual fab 300, as well as their described interconnections, are for purposes of illustration only. For example, it is envisioned that more or fewer entities, both internal and external, may exist within the virtual fab 300, and that some entities may be incorporated into other entities or distributed. For example, the service system 302 may be distributed among the various entities 306-310.

Referring now to FIG. 4. a more detailed illustration of system 100 being integrated into virtual fab 200, 300 is shown. The knowledge represented in conceptual level 102, logical level 104, and implementation level 106 is organized or sliced utilizing an interactive development environment (“IDE”) into three separate layers; the conceptual layer 402, the logic layer 404 and the implementation layer 408. An IDE supports the process of writing software and may include a syntax-directed editor, graphical tools for program entry, and integrated support for compiling and running the program and relating compilation errors back to source code. IDE systems are typically both interactive and integrated. They are interactive in that the developer can view and alter the execution of the program at the level of statements and variables. They are integrated in that, partly to support the above interaction, the source code editor and the execution environment are tightly coupled, allowing the developer to see which line of source code is about to be executed and the current values of any variables it refers to. Example IDEs are Visual C++ and Visual Basic.

Conceptual layer 402 may represent business knowledge from a domain expert 108 (either an individual (such as engineer 306) or another expert system), a production line operation, a pilot line operation, a business management operation, a process operation response operation, or any other type of operational knowledge. Knowledge could be provided from an external source or any entity in the virtual fab, including the service system 302, customer 304, engineer 306, design/lab facility 308, fab facility 310, and process 312. For example, a process engineer expert 108 may convert the experience and knowledge to a conceptual level of DMLD, which may be stored in the conceptual layer 402 and be made available to the expert or information technology (IT) engineers 112, who can implement a set of instructions from the process engineer document into a system. Also, conceptual layer 402 may provide expert 108 with a model for the knowledge contained in an expert system in a widespread view.

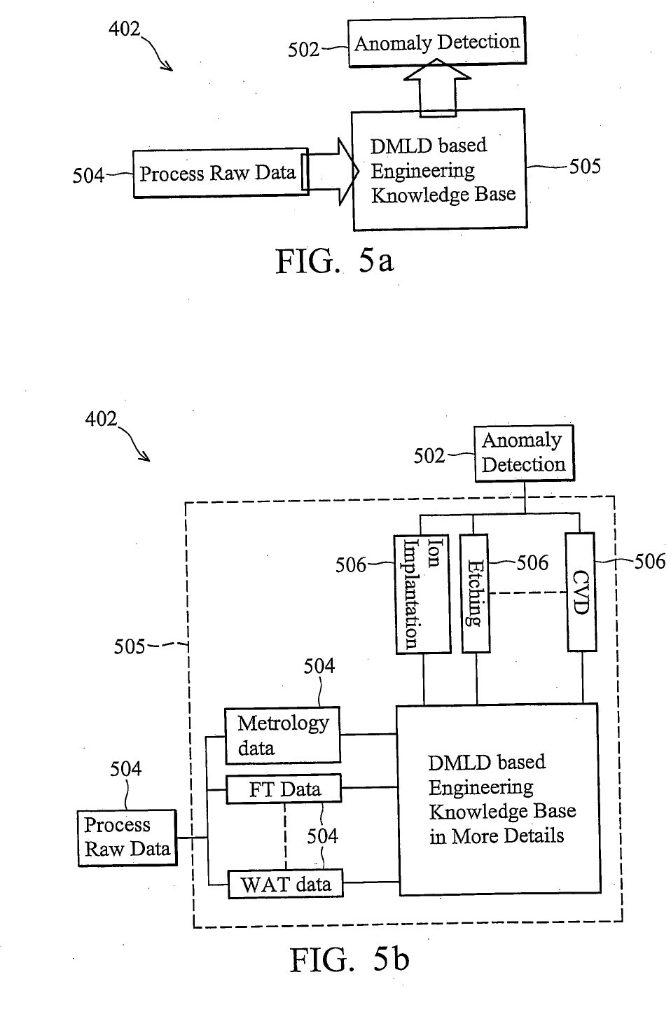

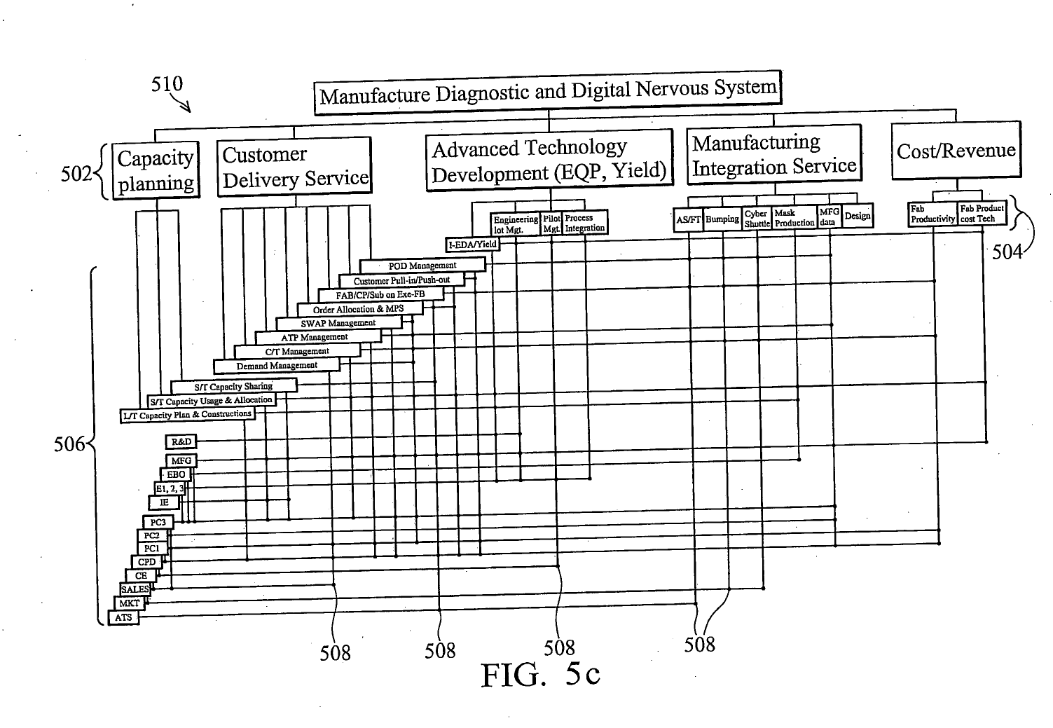

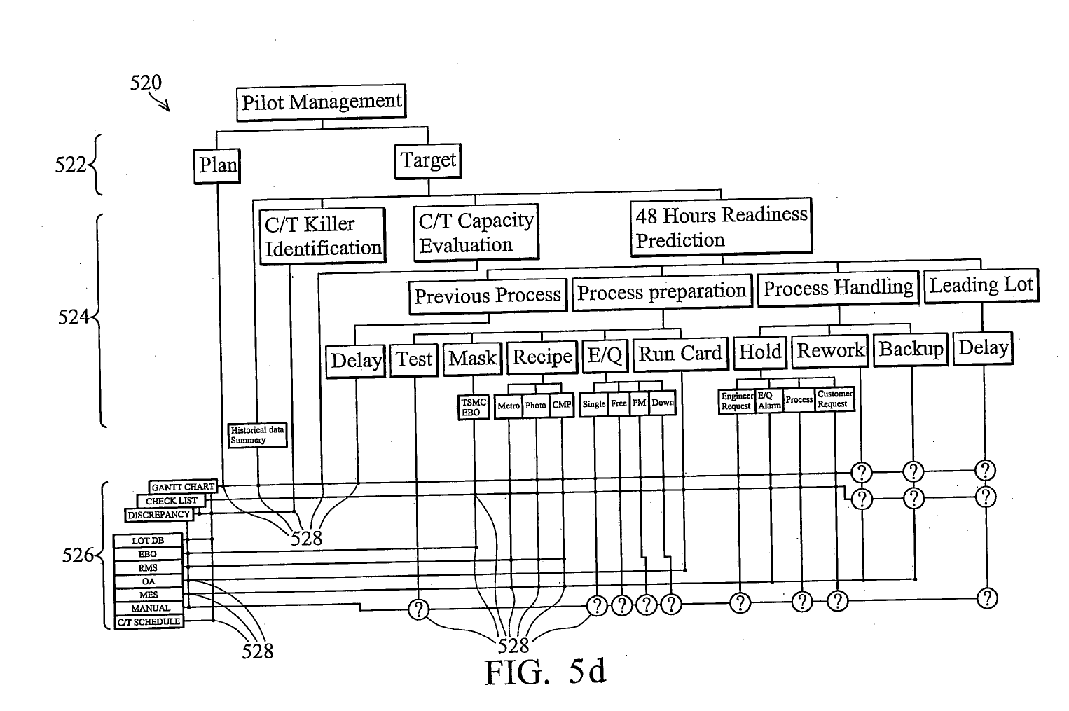

FIGS. 5(a) shows a high-level illustration of a typical conceptual layer 402, which comprises hierarachy of interest with respect to results 502, target 504 and knowledge base 505. Result 502 may constitute a goal or an event in a system. Target 504 may include any data source including a function, a structure or a behavior. Knowledge base 505 may include any type of business knowledge with dependencies on the functions, structures and behaviors. The functions, sources and behaviors may not be absolute, but may vary in intensity and/or duration and may be depicted as such. Both results 502 and targets 504 may have sub-components. For example, FIG. 5(b) shows a more detailed illustration of knowledge base 505, which includes sub-results 506 and specific data source targets, such as metrology data, FT data and wafer acceptance test (“WAT”) data.

FIG. 5(c) shows an example DMLD diagram 510 of a conceptual layer for business knowledge or overall organizational knowledge for a semiconductor manufacture diagnostic and digital nervous center. The diagram 510 shows a plurality of results 502, sub-results 506 and targets 504. Each intersection node 508 denotes the dependencies between the targets 504 to the results 502 and sub-results 506. Diagram 510 may assist an expert 108 in analizing existing results 502 and sub-results 506 and their relvance to a specific bussiness purpose.

The conceptual layer 402 may further provide the foundation of management and response for abnormality detection and response. For example, a conceptual layer may be established for a particle detection and response protocol or for process control protocols that may include equipment maintenance scheduling. In another example, a conceptual layer may be created for a pilot management system such as diagram 520 shown in FIG. 5(d). The diagram shows a plurality of results 522, sub-results 524 and targets 526. Each intersection node 528 denotes the dependencies between the targets 526 to the results 522 and sub-results 524. Diagram 520 may assist an expert 108 in analizing existing results 522 and sub-results 524 and their relvance to a specific bussiness purpose.

Referring back to FIG. 4, logic layer 404 may be coupled to nodes in the conceptual layer 604 to reflect the logical relationship between and target and a vast variety of results, including processing, operations, accessing resource, and any other results that may be added or changed within the logic layer. Logic layer 404 may represent a logical response and action model, where the logic layer could provide further detail for the conceptual layer. An example of a logic layer could be a system for responding and providing action for process contamination and abnormal particle level detection. The logic layer may further include a system for inference that may provide responses and actions based on measured and observed data.

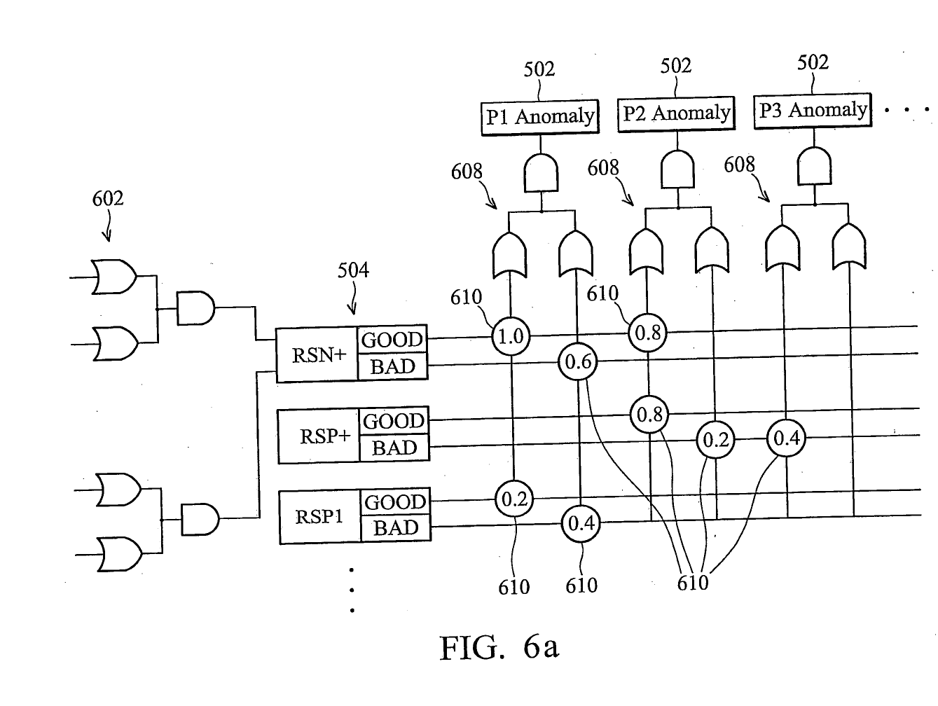

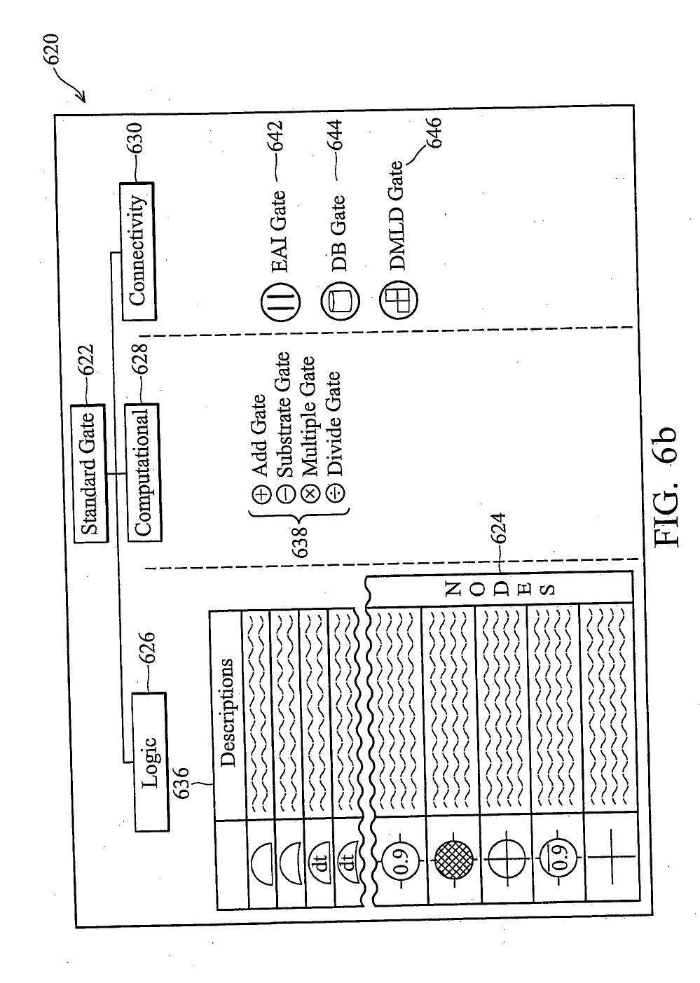

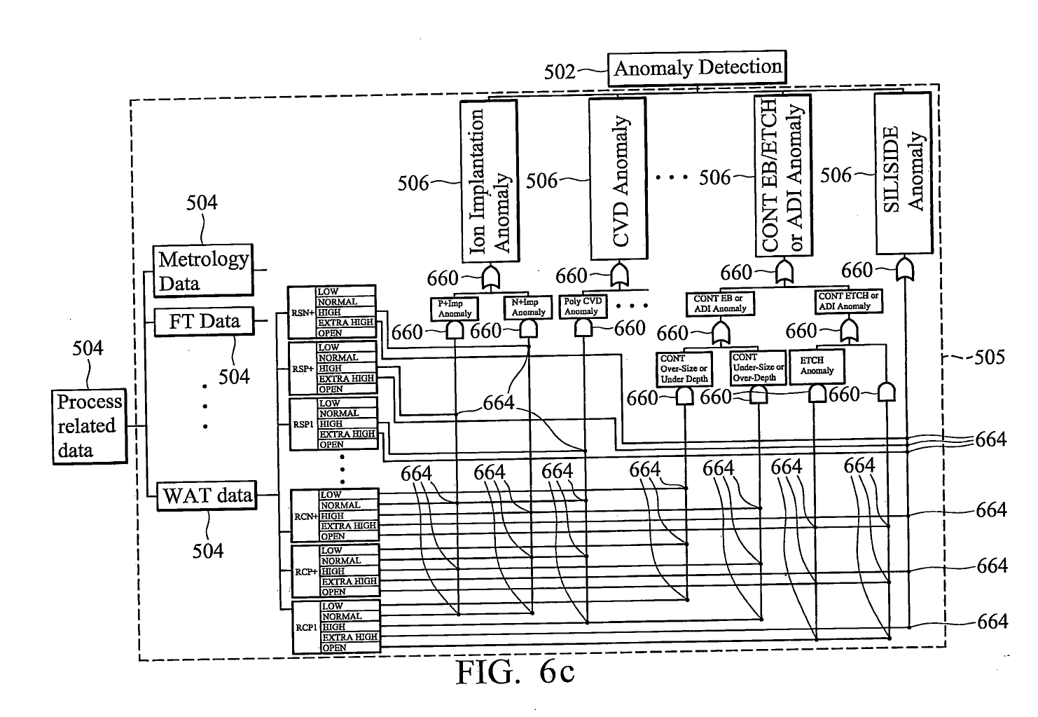

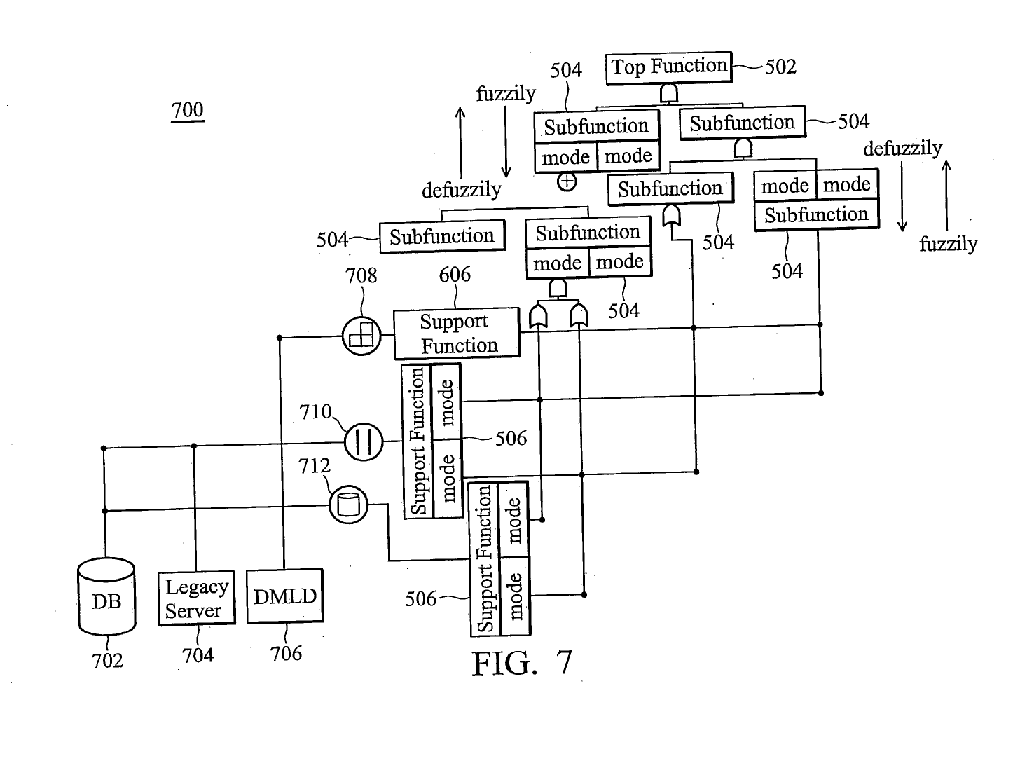

Referring to FIG. 6(a) , diagram 600 provides an illustration of an example logic layer 404. The logic layer 404 may be graphically depicted by a plurality of operators 602 and 608, a plurality of results 502 and targets 504. The logic layer 404 may contain standard gates 602, 608 and intersection nodes 610. Intersection nodes 610 are shown as uncertain nodes, where the number inside the node represents the uncertainty of relationship. The minimum between the input degree of membership function and the uncertainty (i.e., the degree of true relationship) is selected as the output. However, the node may represent any type of relationship. For example, all the nodes shown in table 624 in FIG. 6(b) may be used in logic layer 404.

FIG. 6(b) also illustrates the different types of standard gates 624 and that can be used in logic layer 404 in an embodiment of system 100. There are three different categories of the standard gates 624, which may include logic gate 626, computational gate 628, and connectivity gate 630. The logic gates 626 may include a variety of gates and operators, such as Boolean operators and connectivity points as listed by example in the shown table 636. The computational gate 628 may include standard mathematical operators 638. However, any other type of mathematical functions may be utilized. The connectivity gates 630 may include an EAI gate 642, a DB Gate 644 and a DMLD gate 646. EAI gate 642 may interface to an enterprise application integration (“EAI”) solution, which comprises the use of middleware to integrate application programs, databases and legacy systems involved in the semiconductors manufacture's business processes. The DB gate 644 is used to connect database data sources, including SQL databases. DMLD gate 646 connects conceptual layer 402 and logic layer 404 to other distributed DMLD systems.

Referring back to FIG. 6(a), targets 604 may represent process equipment components such as valves, mass flow controllers, process gases, RF power levels, thermocouples, or any other process equipment. A vast number of views logical level may exist in the logic layer 404, which may include operators 602 and 608, results 502, and targets 504 for each process equipment, operation, and metrology equipment. The logic layer 404 can be a globally encompassing logical response, action, and inference system for a semiconductor manufacturing system.

Logic layer 404 can implement both inference and diagnosis functions. An inference as shown in FIG. 1(c) may occur in the direction where the certain state is detected at the goals or events 610 reflecting possible states of target 504. A diagnosis may be made as to the state of some or all of the targets 504 depending on the state of the goals or events 502.

FIG. 6(c) shows a more detailed implementation of knowledge base 505 of FIGS. 5(a) and 5(b). Gates 660 connect targets 504 to sub-results 506 and results 502 via nodes 664. Nodes 664 may be of any character including those found in table 624 in FIG. 6(b).

Referring back to FIG. 4, the implementation layer 408 may be designed to implement logic layer 404 by generating computer code for accessing the data sources to provide the targets 504. Different roles may focus on different layers wherein all the design jobs can be integrated in a unified development environment. The IDE can encapsulate the conceptual layer 402, a logic layer 404, and an implementation layer 406 into a hierarchical view DMLD.

FIG. 7 shows a graphical representation 700 of the implementation layer 408 showing the connection to the logic layer 404 and conceptual layer 402. Implementation layer 408 provides connectivity and cohesion of the layers through code that connects distributed data sources of various forms, such as databases 702, legacy servers 704, other DMLDs 706 and other interfaces. These data sources contain voluminous quantities knowledge such as scripts, SQL codes, EAI scripts, which are usually create by IT engineers. The implementation layer 408 may further be comprised of DMLD gate 708, EAI gate 710, and DB gate 712, which can serve as the interconnect junctions to the logic layer 404 and the conceptual layer 402. An EAI gate interfaces to an EAI solution, which constitutes middleware that may integrate application programs, databases and legacy systems involved in the semiconductors manufacture's business processes. The DB gate 712 is used to connect database data sources, including SQL databases. DMLD gate 708 connects conceptual layer 402 and logic layer 404 to other distributed DMLD systems. These targets or data resources 504 may contain mass IT knowledge, such as scripts, SQL codes, and EAI scripts.

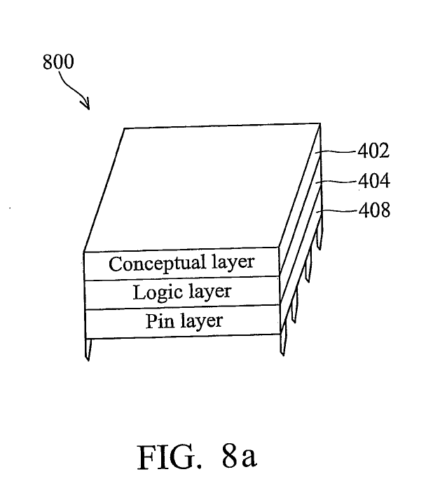

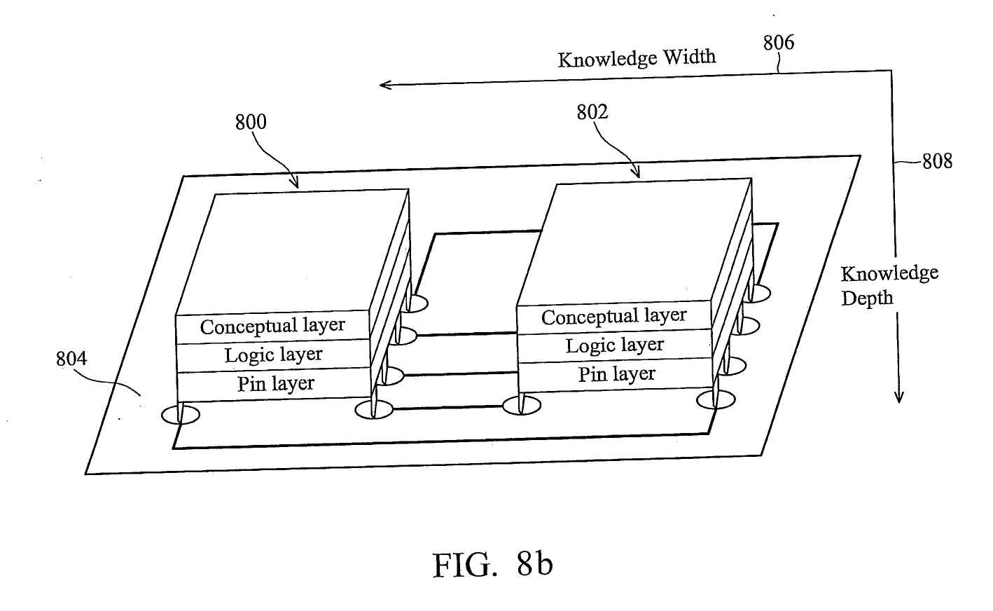

For purposes of illustration only, the conceptual layer 402, the logic layer 404 and implementation layer 408 may be depicted as layers of a DMLD integrated circuit package 800 as shown in FIG. 8(a). The implementation layer 408, the logic layer 404, and the conceptual layer 402 can be each depicted by an array of DMLD integrated circuit packages to model and control the functions of each layer. The purpose of the illustration is to show that of the DMLD integrated circuit packages may be reproduced for other operations or functions 802 and connected with other DMLD integrated circuit packages as shown in FIG. 8(b).

DMLDs 800 and 802 are shown as connected to a substrate 804 for illustration purposes. Substrate 804 may connect a plurality of distributed DMLD integrated circuit packages. The graphical representation of the integration of the distributed DMLD integrated circuit packages 800 and 802 and the substrate 804 shows how the width 806 and depth 808 of accessible knowledge is expanded. The encapsulated DMLD integrated circuit packages 800 and 802 may be used to partition an entire production line for a specific product, a manufacturing of a specific product, or a complete semiconductor manufacturing system within a plurality of other manufacturing systems.

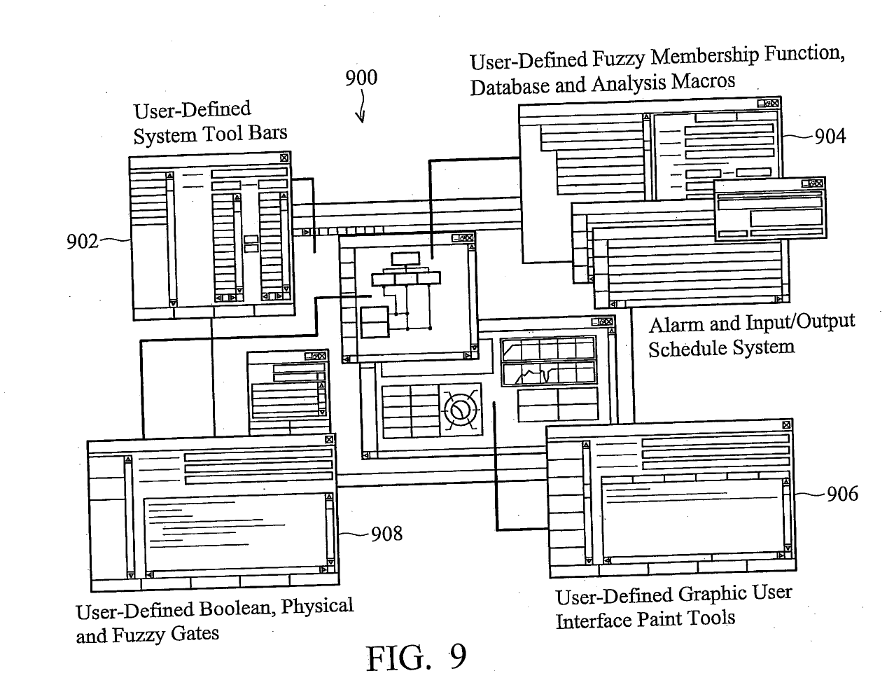

Communication to the encapsulated layers 800, 802 can be preformed through any interface, such as interface 900 shown in FIG. 9 for an alarm and input/output schedule system. Interface 900 may receive user input from any user and provide automated control and maintenance of the encapsulated DMLD. Interface 900 includes user defined interface components, such as system tool bar 905, fuzzy membership function database and analysis macros 904, graphic user interface paint tools 906 and Boolean, physical and fuzzy gates 908.

The present disclosure has been described relative to a preferred embodiment. Improvements or modifications that become apparent to persons of ordinary skill in the art only after reading this disclosure are deemed within the spirit and scope of the application. The present invention may be applied and implemented on a variety of surfaces that may be of any shape—planar, curved, spherical, or three-dimensional. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. A method for managing semiconductor manufacturing knowledge, the method comprising:
defining a hierarchy of interests in the semiconductor knowledge with data targets and results;
storing the hierarchy of interest;
developing a connectivity relationship diagram to reflect the dependency between the data targets and the results;
implementing the connectivity relationship diagram;
coupling the implemented connectivity relationship diagram with the stored hierarchy of interest;
identifying at least one data source for the data targets; and
coupling the implemented connectivity relationship diagram to the at least one data source.

2. The method of claim 1, wherein the connectivity relationship diagram represents physical, logical and uncertain relationships.

3. The method of claim 1, wherein the connectivity relationship diagram is a dynamic master logic diagram.

4. The method of claim 1, wherein the data source is a dynamic master logic diagram.

5. The method of claim 1, wherein the data source is a legacy server.

6. The method of claim 5, wherein the legacy server data is accessed by an enterprise application integrator.

7. The method of claim 1, wherein the data source is a database.

8. The method of claim 1, additionally comprising:
inferring states of the data targets from states of the results; and
diagnosing a source of an anomaly in the data targets.

9. The method of claim 7, additionally comprising
automatically updating the database with the results.

10. A method for managing semiconductor manufacturing knowledge, the method comprising:
defining a hierarchy of interests in the semiconductor knowledge with data targets and results;
storing the hierarchy of interest;
developing a dynamic master logic diagram to reflect the dependency between the data targets and the results;
implementing the dynamic master logic diagram;
coupling the dynamic master logic diagram with the stored hierarchy of interest;
identifying at least one data source for the data targets; and
coupling the dynamic master logic diagram to the at least one data source.

11. The method of claim 10, wherein the a dynamic master logic diagram comprise of a conceptual layer, a logic layer and an implementation layer.

12. The method of claim 10, wherein the data source is a second dynamic master logic diagram.

13. The method of claim 10, wherein the data source is a legacy server.

14. The method of claim 13, wherein the legacy server data is accessed by an enterprise application integrator.

15. The method of claim 10, wherein the data source is a database.

16. The method of claim 14, additionally comprising
automatically updating the database with the results.

17. The method of claim 10, additionally comprising:
inferring states of the data targets from states of the results; and
diagnosing a source of an anomaly in the data targets.

18. A semiconductor manufacturing knowledge management system, comprising:
at least one data source;
a conceptual layer stored in a storage unit; and
a logic layer coupled to the conceptual layer and at least one data source;

19. The system of claim 18 wherein the data source is a legacy server.

20. The system of claim 19 additionally comprising:
an enterprise application integrator couple between the logic layer and legacy server.

21. The system of claim 18 wherein the data source is a database.

22. The system of claim 21 wherein manufacturing requirements documents are stored in the database.

23. The system of claim 22 additionally comprising
an updating mechanism that updates the database with the changes in the conceptual layer.

24. The system of claim 18 additionally comprising:
inference engine coupled to the logic layer to determine states of the data targets; and
diagnosis engine coupled to the logic layer to determine a source of an anomaly in the data targets.
